(19) United States
(12) Patent Application Publication
(10) Pub. No.: US 2018/0077853 A1
(43) Pub. Date: Mar. 22, 2018

(54) Loaded Seed Bullet

(71) Applicants: Paul Dashiell, Tekoa, WA (US); Dave Tellessen, Tekoa, WA (US)

(72) Inventors: Paul Dashiell, Tekoa, WA (US); Dave Tellessen, Tekoa, WA (US)

(73) Assignee: Straw Bullett, LLC, Tekoa, WA (US)

(21) Appl. No.: 15/270,487

(22) Filed: Sep. 20, 2016

(51) Int. Cl. A01C 1/06; A01C 7/08; A01C 7/02; A01G 23/00; A01G 13/02; B64D 1/16; C09K 17/52; C09K 17/18; C09K 17/32

(52) U.S. Cl. CPC A01C 1/06; A01C 7/085; A01C 7/02; A01G 23/00; C09K 17/32; B64D 1/16; C09K 17/52; C09K 17/18; A01G 13/0262

(57) ABSTRACT

A mulch pellet for use in a soil region comprising a plurality of fibers bound together into a rigid pellet body having fertilizing qualities and carrying a polymer outer coating on an outwardly facing surface and further carrying a botanical seed adhered to the pellet body by the polymer outer coating, the pellet body having sufficient mass to provide for targeted distribution onto select soil regions.

### TECHNICAL FIELD

The present invention relates to the field of seed establishment, seed germination and erosion control.

### BACKGROUND OF THE INVENTION

Mulches are known and are typically formed of particulated, and thereafter heated and compressed biomass. Mulches accomplish a number of functions including protecting soil regions and seeds from water and wind erosion, reducing evaporation, increasing humidity in the soil region, moderating temperature fluctuations and dissipating the energy of falling water droplets. Most mulches are formed of particulated paper, or wood products and are notoriously difficult to use and have low performance efficiencies. Additionally, application of paper and wood mulches is generally limited by the amount of water that can be carried by a spreading unit because such mulches are typically spread as a “hydro mulch” using a vehicle based water cannon.

Hydro mulches are “slush” like in nature due to the presence of water used during the spreading operation. Many times the slush-like mulch has a volume of seeds added thereto so that the seeds are distributed at the same time as the mulch, and the mulch, upon drying forms a “blanket” over the seeds and the soil region.

The requirement of large quantities of water for such hydro-mulch dispersion makes hydro-mulch seeding difficult, and also leads to inefficiencies, such as clogging of pipes, hoses and related equipment. Further, the requirement of large quantities of water to facilitate the flows/distribution/spreading of the hydro-mulch limits the use of such mulches to areas proximate to roadways and/or areas having vehicle access.

In geographically remote areas and areas that are not accessible by wheeled vehicles, or track vehicles, the use of water based mulches is impractical due to the weight and volume of the water necessary to facilitate the spreading.

There is a continuing and unmet need for a product that provides the benefits of mulch for seeding, erosion control, seed germination and soil reclamation that is disbursable without large quantities of water and in areas that are remote from roads and without vehicle access.

It is an object of the present invention to produce and provide an agricultural mulch product, and a method of production thereof which provides nutrient constituents to a botanical seed, and the nutrient constituents of the mulch product are released over an extended and predetermined period of time to promote germination of the seed. Further, the mulch product, which is in the form of a rigid pellet body absorbs moisture, such as but not limited to, rain and ground moisture in the soil region in which the pellet body is distributed to provide such moisture to the botanical seed to promote germination, establishment and growth. The pellet body has a mass that resists erosion and is target spreadable without water, such as by aircraft.

As noted previously, in geographic areas that are not assessable by road, or by wheeled/track vehicle, it is difficult to re-establish plant growth, especially native plant growth, in areas that have suffered from wildfires, diseases, and the like. The standard practice for reestablishing native trees and similar vegetation has been to distribute/plant seeds and saplings manually by having individuals carry the seeds/saplings into the area and plant/distribute them manually. This process is manually intensive and slow especially in areas where the individuals must hike for miles in order to begin planting/distributing the seeds and saplings. One example, but not limited thereto, is reestablishing native alpine variety trees in remote wilderness areas and national parks after wildfires, such as in Yellowstone National Park in 1988, and in Glacier National Park in 2015.

An ability to distribute seeds aerially, such as by airplane or helicopter would vastly decrease cost and speed the process of replanting and reestablishment of trees, foliage and groundcover. Because known mulches require large quantities of water for seeding, they are impractical for use in remote areas because the water is heavy and evaporates while falling to the earth. Further, distributing such mulches in a dry form is impractical and inefficient because the lightweight nature of known mulches causes the mulches and related seeds to drift with air currents and prop wash and rotor wash of the distributing aerial vehicle. As such, targeted distribution of the seeds and mulch is both inefficient and nearly impossible. This is especially critical in areas where different types of botanicals grow and flourish at different elevations. For example, various species of alpine spruce only flourish above a sea level elevation of approximately 4,000 feet and on cooler/shaded slopes and huckleberry bushes also only flourish in Alpine like areas from approximately 3000 feet to 10,000 feet, while other types of foliage, such as cedar, only flourish in areas where there is significant water such as creek beds and stream beds and ravines.

A mulch product that carries a botanical seed of a particular variety, and that is subject to targeted distribution across identified/predetermined elevations and geographical features is a continuing unmet need that the instant invention satisfies.

Some or all of the drawbacks, difficulties and the like identified above and other problems, difficulties and drawbacks may be helped and/or solved by the invention shown and described herein. Our invention may also be used to address other problems, difficulties, and drawbacks not set forth above or which are only understood or appreciated at a later date. The future may also bring to light currently unknown or unrecognized benefits which may be appreciated, or more fully appreciated, in the future associated with the novel inventions shown and described herein.

### SUMMARY OF THE INVENTION

A mulch pellet for use in a soil region comprising a plurality of fibers bound together into a rigid pellet body that has fertilizing qualities and an outwardly facing surface. The outwardly facing surface carries an outer coating that extends at least partially about the outwardly facing surface of the pellet body. A botanical seed is carried by at least a portion of the outer coating of the pellet body, and the outer coating and the pellet body disintegrate upon exposure to and absorption of water found in the soil region, and the disintegration of the outer coating and the pellet body releases the absorbed water and the fertilizing qualities into the surrounding soil region, and further provides the absorbed water and fertilizing qualities to the botanical seed to promote germination of the botanical seed within the soil region, to provide erosion control, and to provide soil stabilization.

In a second aspect of the present invention, the pellet body carries a multiplicity of botanical seeds.

In a third aspect of the present invention, the plurality of fibers are straw fibers.

In a fourth aspect of the present invention, the plurality of fibers are organic fibers.

In a fifth aspect of the present invention, the plurality of fibers are synthetic fibers.

In a sixth aspect of the present invention, the outer coating of the pellet body is a polymer.

In a seventh aspect of the present invention, the outer coating of the pellet body is Unicoat™ polymer.

In an eighth aspect of the present invention, the botanical seed is a grass seed.

In a ninth aspect of the present invention, the botanical seed is a tree seed.

In a tenth aspect of the present invention, a plurality of the pellet bodies are dispersed over the targeted soil region by means of an aircraft.

In an eleventh aspect of the present invention, a plurality of the pellet bodies are manually dispersed over the soil region.

In a twelfth aspect of the present invention, the plurality of fibers of the pellet body are bound together by lignin.

In a thirteenth aspect of the present invention, the pellet body contains a nutrient additive that promotes germination of the botanical seed.

In a fourteenth aspect of the present invention, the pellet body contains an additive that promotes water retention within the pellet body.

A still further aspect of the present invention is a mulch pellet for soil stabilization, water retention, germination enhancement, erosion control and seeding of a soil region, the mulch pellet comprising a plurality of particulated straw fibers bound together into a rigid pellet body by lignin and wherein the pellet body has fertilizing qualities and an outer coating extending at least partially about an outwardly facing surface of the pellet body. A botanical seed carried at least in part by the outer coating of the pellet body, and wherein the outer coating and pellet body disintegrate upon exposure to and absorption of water found in the soil region, and the disintegration of the outer coating and the pellet body releases the absorbed water and fertilizing qualities into the soil region and provides the absorbed water and fertilizing qualities to the botanical seed to promote germination of the botanical seed in the soil region, to promote soil stabilization, to promote water retention and to promote erosion control.

An even still further aspect of the present invention is a method for making a mulch pellet for soil stabilization, water retention, erosion control, germination enhancement and seeding of a soil region comprising the steps of first adding a predetermined volume of predetermined botanical seeds to a predetermined volume and predetermined concentration of a fluidic polymer so that the predetermined volume of predetermined botanical seeds are substantially coated with the fluidic polymer and are suspended within the predetermined volume and predetermined concentration of the fluidic polymer. Second, placing a volume of mulch pellets in an interior volume of a rotating drum so that the mulch pellets are randomly tumbled within the interior volume of the rotating drum. Third, adding the predetermined volume and predetermined concentration of the fluidic polymer containing the predetermined volume of predetermined botanical seeds into the interior volume of the rotating drum containing the volume of mulch pellets while the drum rotates so that the fluidic polymer containing the botanical seeds coats at least a portion of each mulch pellet within the rotating drum creating an outer coating on at least a portion of substantially each mulch pellet. Fourth, removing the mulch pellets that are at least partially coated with the fluidic polymer carrying the botanical seeds from the interior of the drum and drying the fluidic polymer coated botanical seed carrying mulch pellets so that the outer coating hardens and affixes the botanical seed to the mulch pellet.

A seventeenth aspect of the present invention further includes the step of adding a nutrient additive to the rotating drum containing the mulch pellets that promotes germination of the botanical seed.

An eighteenth aspect of the present invention further includes the step of adding an additive to the rotating drum containing the mulch pellets that promotes water absorption of the mulch pellets.

### BRIEF DESCRIPTION OF THE DRAWINGS

Disclosed forms, configurations, embodiments and/or diagrams relating to and helping to describe aspects and version of our invention are explained and characterized herein, often with reference to the accompanying drawings. The drawings and features shown herein also serve as part of the disclosure of our invention, whether described in text or merely by graphical disclosure alone. The drawings are briefly described below.

FIG. 1 is an artist's representation of a representative mulch pellet of the present invention, showing a partial cutaway orthographic side and end view of a pellet body showing the matrix of fibers comprising the pellet body, and showing the outer coating over and about a portion of the pellet body, the outer coating securing two botanical seeds to the pellet body.

### DETAILED DESCRIPTION OF THE PREFERRED EMBODIMENTS

This disclosure of the invention is submitted in furtherance of the Constitutional purposes of the U.S. Patent Laws “to promote the progress of science and useful arts.” (Article 1, Section 8).

The readers of this document should understand that dictionaries were used in the preparation of this document. Widely known and used in the preparation hereof are the American Heritage Dictionary of the English Language, 4^{th} Edition, copyright 2000, Webster's New International Dictionary, Unabridged, (2^{nd} Edition, copyright 1957), Webster's Third New International Dictionary (copyright 1993), the Oxford English Dictionary (2^{nd} Edition, copyright 1989), and the New Century Dictionary (copyright 2001-2005), all of which are hereby incorporated by this reference for interpretation of terms used herein and to more adequately or aptly describe various features, aspects and concepts shown or otherwise described herein using words having meanings applicable to such features, aspects and concepts.

This document is premised upon using one or more terms within one embodiment that may also apply to other embodiments for similar structures, functions, features and aspects of the invention. Wording used in the Claims is also descriptive of the invention, and the text of both the Claims and the Abstract are incorporated by this reference into this written description entirely.

Our loaded seed bullet generally provides a body 10 that has a first end portion 11, an opposing second end portion 12, an outwardly facing surface 13, a diameter 14, and a length 15.

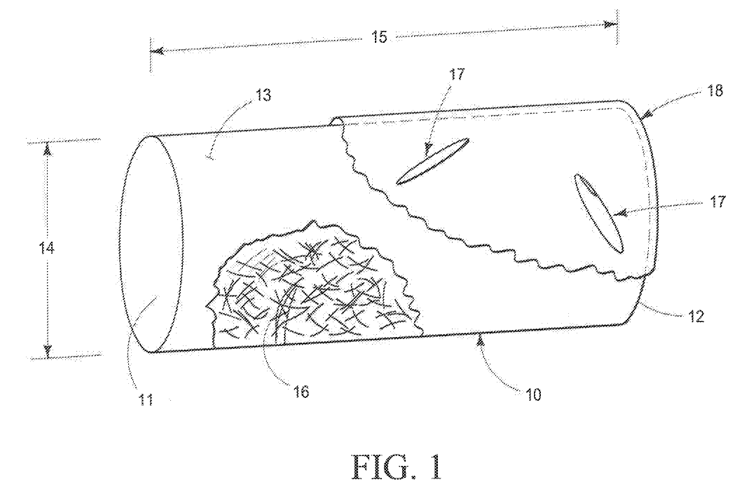

As shown in FIG. 1, the body 10 may be generally cylindrical in configuration, however it is contemplated that other configurations are also possible as the pellets are commonly formed by an extrusion process wherein a plurality of fibers 16 are compressed and heated so that lignin material (not shown) that is naturally present in plant products becomes somewhat adhesive and causes the fibers 16 to adhere to one another in a generally rigid body 10. The outwardly facing surface 13 may be curvilinear, or may be rectilinear depending upon the configuration and shape of a die orifice (not shown) used in the extrusion process.

In the contemplated embodiment, the fibers 16 are straw fibers that are processed through a known hammer mill (not shown) which particulates larger straw material into smaller fibers 16. The hammer mill process reduces the straw material in size, and allows the pellet bodies 10 to be formed. The hammer mill process is also effective in increasing surface area of the fibers 16 to promote the consolidation of the fibers 16 into the pellets and in the expressing of lignin from the straw fibers 16 so that the lignin may react with the heat during the extrusion process causing the fibers 16 to consolidate into a rigid body 10. The pressing of the fibers 16 into the rigid body 10 is important because the bodies 10 need a mass/weight to facilitate effective targeted distribution into targeted areas.

In the extrusion process (not shown) the pellet bodies 10 are extruded through a die orifice (not shown) under high pressure and heat. The forcing of the fibers 16 through the die consolidates the fibers 16 into the rigid body 10, and also defines the outwardly facing surface 13 extending about the consolidated fibers 16. The length 15 of the pellet body 10 is variable as the extruded mass breaks from the die during the extrusion process. The diameter 14 of the pellet body 10 is generally consistent as the diameter 14 is determined by a diameter of the die. In known extrusion processes, multiple die orifices may be defined in a single die so that multiple pellet bodies 10 are extruded simultaneously which increases production volume.

An outer coating 18 is carried on at least a portion of the outwardly facing surface 13 of each pellet body 10. In the preferred embodiment, the outer coating 18 is formed of a polymer that is produced by Universal Coating Systems, Inc. of Pratt Kans., USA, and Independence Oregon, USA and is sold under the tradename of “Unicoat™”. The Unicoat™ polymer is a water soluble material that is originally fluidic in nature and flowable, When exposed to air, the Unicoat™ outer coating 18 solidifies forming a hard surface. The outer coating 18 is water soluble, and when exposed to water, the outer coating 18 disintegrates into its component elements, all of which are biodegradable and nontoxic.

At least one, and preferably plural botanical seeds 17 are adhered to the outwardly facing surface 13 of each pellet body 10 by the outer coating 18. The botanical seed 17 may be any of a variety of seeds, such as, but not limited to, grass seeds, tree seeds, bush seeds, shrubs seeds, and the like, With more particularity botanical tree seeds 17 may be any of a variety of species, such as but not limited to, alpine spruce, cedar, fir, pine, conifer, deciduous and the like, depending upon which geographical area, and which geographical elevation is the intended target distribution soil region of the loaded seed bullets of the instant invention.

Similar to the outer coating 18, the rigid nature of each pellet body 10 disintegrates upon exposure to an absorption of water. As such, when the loaded seed bullet of the instant invention is exposed to water (e.g., rain, surface water, atmospheric moisture, dew, etc.), and the like, the outer coating 18 disintegrates, and the body 10 comprised of the fibers 16 expands as the lignin therein decomposes and deteriorates. The expansion of the body 10 releases the absorbed water, and fertilizing nutrients contained within the fibers 16 to provide nutrients and moisture and coverage to the botanical seed 17 to promote germination of the botanical seed 17 wherever the botanical seed 17 may be/have landed.

In the preferred embodiment, the body 10 has a preferred length 15 of approximately about 1.0 cm to approximately about 5.0 cm and more preferably between approximately 2.0 cm and 4.0 cm, and a diameter 14 of approximately about 4.0 mm to approximately 9.0 mm so that the body 10 has an appreciable mass that is influenced by gravity during spreading/dispersion. The mass of the body 10 facilitates targeted distribution of the loaded seed bullets from aircraft such as airplanes and helicopters.

It is widely recognized that germination of seeds 17 is more likely to occur when a quantity of mulch overlays the botanical seed 17 to provide nutrients, moisture and protection to the seed 17. Such overlayment of a mulch product can only be assured when the seeds 17 are distributed first and thereafter the mulch product is distributed over/on top of the seeds 17. Such a process requires, at a minimum, two passes of the distributing means. In contrast, our invention is different from known mulch and seed distribution processes/methods.

Our invention's adherence/affixing of the botanical seeds 17 directly upon the pellet body 10 allows the mulch pellet 10 (the nutrients) and the seed 17 to be distributed simultaneously with a single pass of the aircraft without a need for subsequent or secondary/tertiary passes of the aircraft over the same area to subsequently distribute nutrients and mulch coverage and the like over the previously dispersed seeds.

The ability to target distribute seeds and mulch simultaneously into and onto specific predetermined geographic areas and elevations allows for effective enhanced soil protection, soil erosion and replanting of areas that have suffered from forest fires, disease and the like.

The method for making our loaded seed bullets comprises the steps of adding a predetermined volume of predetermined desired botanical seeds 17 to a predetermined volume and predetermined concentration of the fluidic polymer outer coating 18 within a container (not shown). The mixture of polymer outer coating 18 and botanical seeds 17 is agitated sufficiently so that the botanical seeds 17 are substantially coated with the polymer outer coating 18.

A volume of mulch pellet bodies 10 is added to an interior volume of a known rotating drum (not shown) and the drum is activated by known means so that the pellet bodies 10 are randomly and continuously tumbled within the interior volume (not shown) of the rotating drum. While the volume of pellet bodies 10 are randomly and continuously tumbling within the rotating drum, a quantity of the mixture of fluidic polymer outer coating 18 and botanical seeds 17 is added to the interior of the rotating drum. During the continuous and random tumbling of the pellet bodies 10, the polymer outer coating 18 and the botanical seeds 17 are coated upon the pellet bodies 10 and the “stickiness” of the polymer outer coating 18 affixes the botanical seeds 17 to the outwardly facing surface 13 of substantially all of the pellet bodies 10. After a period of tune of tumbling within the drum, the now coated pellet bodies 10 are removed from the drum and allowed to dry. Although air drying is preferred because air drying does not negatively affect the viability of the botanical seeds 17, it is contemplated that the drying may be hastened by heated air drying as well. In the event of heated drying, temperatures need to be actively controlled and monitored and maintained to avoid damaging the viability of the botanical seeds 17, some of which may be negatively affected by exposure to high temperatures.

The outer coating 18 adheres at least one, and preferably plural botanical seeds 17 to the outwardly facing surface 13 of each body 10. After drying, the loaded seed bullets/pellets are collected into a volume and thereafter target distributed onto a soil region that is desirable for the particular botanical seeds 17 affixed to the pellet bodies 10.

The mass of the body 10 carrying the botanical seed 17 and the outer coating 18 is generally sufficient to cause the body 10 to fall somewhat vertically downwardly during aerial distribution onto a target soil region so that specific identified varieties of botanical seeds 17 may be distributed across specifically targeted soil regions. Upon each pellet body's 10 exposure to water in the soil region which may be from falling precipitation, cloud moisture, ground water, dew or otherwise, the outer coating 18 disintegrates because of its water soluble nature. The body 10 further absorbs the water causing the body 10 to expand and the lignin material binding the fibers 16 together to decompose and disintegrate allowing the fibers 16 to release moisture and fertilizing qualities over and about and immediately adjacent to the botanical seeds 17 to promote germination of the botanical seed 17 and to protect the seed 17 from erosion forces.

In a further contemplated embodiment, an additive, which may be a fertilizer, such as, but not limited to nitrogen, or a water attractant may be added to the fibers 16 during the extrusion process, or during the tumbling within the drum so that the additive is bound within the fibers 16 and is thereafter available to and provided to the botanical seed 17.

It is still further contemplated the additive (not shown) may be added to the polymer outer coating 18 and the botanical seeds 17 during the mixing thereof prior to application to the pellet bodies 10. Regardless of the time of addition, the additives are thereafter available to the botanical seed 17 to promote, enhance and otherwise benefit germination of the botanical seed 17 and establishment of a plant resulting from the botanical seed 17.

### Operation

A quantity of pellet bodies 10, each at least partially coated with the outer coating 18 on the outwardly facing surface 13, and each body 10 carrying at least one, and possibly plural botanical seeds 17 are loaded into a distribution means (not shown) such as, but not limited to, an aircraft or a helicopter or other known distribution means. The quantity of pellet bodies 10 are transported by the distributing means to a predetermined identified soil region that needs to be re-planted. The bodies 10 are distributed from the distribution means as the distribution means passes over the identified soil region. The bodies 10 fall generally vertically downwardly, under the influence of gravity, onto the soil region. Over a period of time, the bodies 10 absorb water/moisture from the soil region and the water/moisture causes the outer coating 18 and the lignin within the pellet body 10 to degrade and disintegrate. The disintegration of the outer coating 18 releases the botanical seed 17 onto the surface of the soil region, and the disintegration of the lignin within the pellet body 10 allows the fibers 16 within the body 10 to decompose and diffuse to provide nutrients and coverage and moisture to the adjacent botanical seed 17 to promote germination of the botanical seed 17 and to provide some amount of protection to the botanical seed 17, such as from erosion forces. Over a period of time, the botanical seed 17 will germinate using the nutrients provided by the fibers 16 comprising the body 10 and any additives that had been added to the body 10 during the formation of the body 10 or coating of the body 10.

We claim:

1. A mulch pellet for use in a soil region comprising:
a plurality of fibers bound together into a rigid pellet body having fertilizing qualities and an outwardly facing surface, and wherein an outer coating extends at least in part about the outwardly facing surface of the pellet body;
a botanical seed carried by at least a portion of the outer coating of the pellet body; and wherein
the outer coating and pellet body disintegrate upon exposure to and absorption of water found in the soil region, and the disintegration of the outer coating and pellet body releases the absorbed water and fertilizing qualities into the surrounding soil region and further provides the water and fertilizing qualities to the botanical seeds to promote germination of the botanical seeds within the soil region.

2. The mulch pellet of claim 1 wherein a plurality of botanical seeds are carried by at least a portion of the outer coating.

3. The mulch pellet of claim 1 wherein the plurality of fibers are straw fibers.

4. The mulch pellet of claim 1 wherein the plurality of fibers are particulated straw fibers.

5. The mulch pellet of claim 1 wherein the plurality of fibers are organic fibers.

6. The mulch pellet of claim 1 wherein the plurality of fibers are synthetic fibers.

7. The mulch pellet of claim 1 wherein the outer coating is a polymer.

8. The mulch pellet of claim 1 wherein the outer coating is Unicoat™ polymer.

9. The mulch pellet of claim 1 wherein the botanical seed is grass seed.

10. The mulch pellet of claim 1 wherein the botanical seed is tree seed.

11. The mulch pellet of claim 1 wherein a plurality of mulch pellets are air disbursed over the soil region.

12. The mulch pellet of claim 1 wherein a plurality of mulch pellets are manually disbursed over the soil region.

13. The mulch pellet of claim 1 wherein the plurality of fibers of the pellet body are cohesively bound together by lignin material.

14. The mulch pellet of claim 1 further comprising:
a nutrient additive within the pellet body that promotes germination of the botanical seed.

15. The mulch pellet of claim 1 further comprising:
an additive within the pellet body that promotes water retention within the pellet body.

16. A mulch pellet for soil stabilization, water retention, germination enhancement and seeding of a soil region, the mulch pellet comprising:
particulated straw fibers bound together into a rigid pellet body having fertilizing qualities and having an outer coating extending at least partially about an outwardly facing surface of the pellet body;
a botanical seed carried at least in part by the outer coating of the pellet body; and wherein
the outer coating and pellet body disintegrate upon exposure to and absorption of water found in the soil region and the disintegration of the outer coating and pellet body releases the absorbed water and fertilizing qualities into the soil region and provides the absorbed water and fertilizing qualities to the botanical seeds to promote germination of the botanical seed in the soil region.

17. A method for making a loaded mulch pellet for soil stabilization, water retention, germination enhancement and seeding of a soil region comprising the steps:
first adding a predetermined volume of botanical seeds to a predetermined volume and predetermined concentration of fluidic polymer so that the predetermined volume of botanical seeds are substantially coated with the fluidic polymer and are suspended within the predetermined volume and predetermined concentration of fluidic polymer;
second placing a volume of mulch pellets in an interior volume of a rotating drum so that the mulch pellets are randomly tumbled within the interior volume of the rotating drum;
third adding the predetermined volume and predetermined concentration of fluidic polymer containing the predetermined volume of botanical seeds into the interior volume of the rotating drum containing the volume of mulch pellets while the drum rotates so that the fluidic polymer containing the botanical seeds coats at least a portion of each mulch pellet within the rotating drum creating an outer coating on at least a portion of each mulch pellet; and
fourth removing the fluidic polymer and botanical seed coated mulch pellets from the drum and drying the fluidic polymer and botanical seed coated mulch pellets so that the outer coating hardens and affixes a botanical seed to the mulch pellet.

18. The method of claim 17 further comprising the step:
adding into the interior of the rotating drum an additive that promotes germination of the botanical seed so that the additive is carried with the mulch pellets.

19. The method of claim 17 further comprising the step:
adding into the interior of the rotating drum an additive that promotes water absorption of the mulch pellet so that the additive is carried with the mulch pellets.
